(19) United States
(12) Patent Application Publication
(10) Pub. No.: US 2013/0135238 A1
(43) Pub. Date: May 30, 2013

(54) PORTABLE DEVICE COMPRISING A TOUCH SCREEN AND CORRESPONDING METHOD OF USE

(71) Applicants: David Naccache, Paris (FR); Guillaume Andre, Valence (FR); Vincent Hernandez, Oytier Saint Oblas (FR); Jean-Jacques Delorme, Saint-Marcel-les-Valence (FR); Jean-Louis Sarradin, Etables (FR); Frederic Bern, Paris (FR); Thierry Marsaud, Talence (FR); Jean-Louis Olive, Valence (FR)

(72) Inventors: David Naccache, Paris (FR); Guillaume Andre, Valence (FR); Vincent Hernandez, Oytier Saint Oblas (FR); Jean-Jacques Delorme, Saint-Marcel-les-Valence (FR); Jean-Louis Sarradin, Etables (FR); Frederic Bern, Paris (FR); Thierry Marsaud, Talence (FR); Jean-Louis Olive, Valence (FR)

(73) Assignee: Compagnie Industrielle et Financiere D'Ingenierie "Ingenico", Paris (FR)

(21) Appl. No.: 13/697,507

(22) PCT Filed: May 6, 2011
(86) PCT No.: PCT/EP2011/057352

§ 371 Date: Feb. 1, 2013

(30) Foreign Application Priority Data
May 12, 2010 (FR) 1053718

(51) Int. Cl. G06F 3/041

(52) U.S. Cl. CPC G06F 3/041
USPC 345/173

(57) ABSTRACT

A portable device is provided, which includes a touch screen and at least one area bearing reference information, referred to as a reference area, which can be identified by detecting a variation in the surface state on the device.

### CROSS-REFERENCE TO RELATED APPLICATIONS

This application is a Section 371 National Stage application of International Application No. PCT/EP2011/057352, filed May 6, 2011, which is incorporated by reference in its entirety and published as WO 2011/141391 on Nov. 17, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of devices comprising touch screens.

More specifically, the disclosure pertains to such portable devices and to the improving of these devices with a view to their use by a user with visual deficiency, for example a user who is visually impaired or sightless. Here below, such a user shall be denoted as a “sightless user”.

In particular, the disclosure can be applied to electronic payment terminals comprising touch screens of this kind.

### BACKGROUND OF THE DISCLOSURE

To date, there are an increasing number of devices comprising touch screens, for example mobile telephones, personal digital assistants (PDAs), laptop computers, automatic cash dispensers, as well as business cash registers.

There are also electronic payment terminals comprising touch screens. Here, a touch screen of this kind has for example a virtual keyboard for validating a confidential code or the amount of a transaction.

One drawback of these electronic payment terminals however lies in the fact that they cannot be used by a sightless user. Indeed, unlike in the case of electronic payment terminals comprising a screen and a keyboard on which the keys are in relief and where some keys have a tactile marking on their surface (in particular the digit 5 and the “enter”, “correct” or “cancel” keys), each key of the virtual keyboard of an electronic payment terminal comprising a touch screen which be detected only visually.

There is a therefore a need for novel portable devices comprising touch screens enabling their use by any user, including sightless users.

### SUMMARY

An embodiment of the invention proposes a novel solution to this problem in the form of a portable device comprising a touch screen and at least one area carrying a piece of position-marking information, called a position-marking area, identifiable by the detection of a variation of a surface state on said device.

According to this embodiment, the invention enables the use of a portable device and its touch screen by a user having visual deficiency, by means of a piece of position-marking information detectable by touch, for example in relief or in the form of a change of “texture” (alternating rough and smooth surfaces, or else a change of material detectable by touch) on a surface of the device.

The position-marking information may for example signify that the place in which it is situated is in the middle of the width or height (in the middle of a side) of the screen or again facing a particular place of a tactile area with which the screen is provided (a corner, a key of a keyboard represented on the screen etc).

Such a portable device is especially an electronic payment terminal, the screen of which can represent has a virtual keyboard, for example for the keying in of a confidential code or an amount of a transaction.

According to one embodiment of the invention, the position-marking information appears in relief relatively to at least one surface of said device.

According to one embodiment of the invention, a device of this kind is provided with means for deactivating the display of said touch screen.

Thus, when the device is in mode of use by a sightless user, an embodiment of the invention provides for a system of security so that nothing is displayed on the touch screen since a sightless user has no need of any display on the touch screen. Thus, a malicious individual watching the sightless user (for example when the latter enters his PIN code) without his knowledge is unable, from observation, to deduce the keys being activated by the sightless user.

According to another aspect of an embodiment of the invention, such a device also comprises at least one key outside said touch screen.

Thus, when the touch screen represents a virtual keyboard, certain keys such as the “enter”, “cancel” and “correct” function keys are not provided on the touch screen but outside, like the “classic” keyboard keys.

In this way, there are a smaller number of keys requiring position marking in relief according to an embodiment of the invention. This embodiment therefore presents satisfactory ergonomy for the user.

In particular, the position-marking information corresponds to a marking demarcating a boundary between two distinct virtual regions of the touch screen.

Thus, according to this embodiment, a piece of position-marking information is used not to represent a virtual region of the screen but to demarcate a boundary between two virtual regions of the touch screen, one region possibly corresponding to a key, or a set of keys.

In this way the user, knowing the predefined organization of these regions, can locate the regions themselves on the touch screen, for example from the keys of a virtual keyboard in a case where a region corresponds to a key.

According to a first variant, the marking represents a boundary between two virtual keys of said touch screen.

Thus, according to this embodiment, a marking is used to demarcate a boundary between two keys of a touch screen, representing for example a virtual keyboard. In this way, the user, knowing the predefined organization of the keys of the touch screen, can locate each of the keys by identifying the boundaries between them.

For example, the boundaries may be demarcated by a short line, perpendicular to the external edge of the touch screen.

Thus, twelve position markings are used to demarcate the boundaries between the keys of the digits 0 to 9 as well as the “enter” and “cancel” keys when these keys are themselves situated at the periphery and not at the center of the touch screen.

If the virtual keyboard represented on the touch screen has keys at the periphery and the center of the touch screen, ten markings are used to demarcate the boundaries between the keys of digits 0 to 9 as well as the “enter” and “cancel” keys.

According to another variant, the marking demarcates the middle of one side of said touch screen and, therefore if, advantageously, a marking is considered for the middle of each of the four sides of the screen (in the case of a rectangular or square-shaped screen), then the outline of the touch screen itself is marked.

In this way, if the touch screen represents a virtual keyboard, the user, knowing the predefined organization of the keys on the touch screen, can deduce the location of each of the keys by identifying the middles and therefore the sides of the touch screen and therefore the outlines of the touch screen itself. In this case, four markings can suffice, for example dots, or short lines perpendicular to the sides of the screen.

According to another variant, the marking demarcates one side of said touch screen and, therefore, if we advantageously consider one marking for each of the four corners of the screen (in the case of a rectangular or square shaped screen), then the outline of the touch screen itself is marked.

In this way, if the touch screen represents a virtual keyboard, the user knowing the predefined organization of the keys on the touch screen can deduce the location of each of the keys by identifying the corners, and therefore the touch screen itself. In this case, four markings are necessary, for example dots or short lines or any other shape.

According to another aspect of an embodiment of the invention, the position-marking area is situated along at least one edge of said touch screen.

This embodiment enables the position-marking, for example, of different keys of the touch screen in placing different markings along at least one edge of the touch screen or even all around the touch screen. In this case, the markings are close to the corresponding keys in the touch area or are facing these keys and offer the user satisfactory ergonomy.

According to one embodiment of the invention, the piece of position-marking information corresponds to a marking that demarcates the width of a virtual key of the touch screen.

For example, the marking corresponds to a rough strip corresponding to the width of a virtual key. For example, it is possible to provide for an alternation of rough strips and smooth areas to mark off the widths of the contiguous keys.

According to one particular aspect of an embodiment of the invention, the position-marking area is situated outside the touch screen and obtained by a technique belonging to a group comprising:

an embossing of a surface of the device;

an etching of the surface of the device;

a combination of the above techniques.

Thus, the position is located advantageously, without touching the touch screen because the position-marking area is located outside the touch screen. In this way, there is no risk that the user will involuntarily activate an application or enter erroneous information through the touch screen.

Thus, should the touch screen represent a virtual keyboard with keys corresponding for example to digits and “enter” keys or “cancel” keys, then the user first of all, through the piece of position-marking information, locates a key that he wishes to activate and then moves his finger (or a stylus) on the touch screen in order to activate the position-marked key.

This movement of his finger or of a stylus is done according to a predetermined criterion.

For example, the user knows a configuration of the keys represented on the touch screen and knows that when he locates the number “1” for example, the key of the corresponding touch screen is to the right of the marking whereas, when he locates the number “4” for example, the corresponding key of the touch screen is beneath the marking or when he locates the number “8” for example, the corresponding key of the touch screen is to the left of the marking.

When the relief of the locating area is obtained by embossing, the pieces of position-marking information, or markings, project out of the surface of the device. Conversely, when the relief of the position-marking area is obtained by etching, the markings appear as hollows below the surface of the terminal. The choice of the technique for obtaining the position-marking area can thus be matched to the type of surface of the device or to goals related to manufacturing costs etc.

According to yet another aspect of an embodiment of the invention, the position-marking area is obtained by a technique for coating the surface of the touch screen of the device with an optical varnish.

Thus, it is possible for example to mark the virtual keys of the touch screen by a marking in relief, through the depositing of an optical varnish that does not harm the tactile function of the screen but, according to an embodiment of the invention, enables a sightless user to use the touch screen.

For example, when the position-marking area is obtained by a coating of the surface of the touch screen of the device with an optical varnish, the position-marking information corresponds to a marking that demarcates a predetermined key, for example the numeric key “5”, of the touch screen.

According to one embodiment of the invention, the position-marking areas are situated on at least one side of the device.

The markings in relief are for example situated on one of the sides/edges of the device or on a surface not parallel to the surface of the touch screen.

In particular, the position-marking information corresponds to a representation in braille of at least one virtual key of the touch screen.

This embodiment provides for marking the keys by using their representation in braille, thus making it possible for the user to directly read the key through the position-marking area.

For example, this embodiment makes it possible to represent the keys of digits from 0 to 9 as well as the “enter”, “correct” or “cancel” keys.

Thus, for example, when the keys of the touch screen are themselves situated on the periphery and not at the center of the screen, the pieces of position-marking information can be placed on the external periphery of the touch screen. In this case, twelve markings are used to represent the keys of digits 0 to 9 as well as the “enter” and “cancel” keys.

The pieces of position-marking information can also correspond to the function of the virtual key. For example when the keys concerned are numeric keys, then the corresponding numbers are marked in relief according to an embodiment of the invention.

According to one particular aspect of an embodiment of the invention, the device is provided with audio means capable of guiding a user in browsing through an application rendered on the touch screen.

Thus, when the user has to navigate within an application, for example before keying in his PIN code, he is guided by audio indications that do not present any security risk but enable him to access the screen to enter his PIN code. For example, the audio indications indicate the amount of the transaction before the user enters his PIN code.

According to yet another embodiment of the invention, the device is provided with disabling means by which the activation of a virtual key of said touch screen by pressure on the part of a user is made subject to the execution of an additional action by the user.

This embodiment necessitates a different technique for activating the keys, by an additional action by the user in addition to pressure on the key considered. Indeed, the user necessarily presses on the touch screen to pass from one key to another and this should not be interpreted as the activation of each of the keys pressed in succession. The user must therefore carry out an additional action if he wishes to validate the activation of the key that he has pressed.

For example, this additional action of the user may be a “double pressure” on the key considered.

This characteristic can be advantageously combined with a position-marking of the keys, for example by representing them in Braille, as described here above. For example, the user can shift his finger both on the position-marking information in Braille and on the touch screen. Thus, he can both read the Braille script by touching the position-marking area and slide his fingers on the touch screen without fearing that he might involuntarily enter a key.

According to one embodiment of the invention, the device is provided with means for signaling the activation of a virtual key on the touch screen.

Thus, an audio emission for example or else a vibration of the device succeeds the validation of the key in order to confirm to the user that the keying-in action has truly been taken into account by the device.

Advantageously, these signaling means are present on the device for all the embodiments described here above.

Another aspect of an embodiment of the invention pertains to a method for activating a key of a touch screen of a device as described here above comprising the following steps:
pressing at least one intermediate area situated between two regions of the touch screen and the key;
implementing an additional action for activating the key.

An embodiment of the invention therefore also pertains to a method for using a device as described here above, for which there is planned a different technique for activating the keys, by an additional action of the user, in addition to pressure on the key considered.

### BRIEF DESCRIPTION OF THE DRAWINGS

Other features and advantages shall appear more clearly from the following description of a particular embodiment given by way of a simple, illustratory and non-exhaustive example and from the appended figures, of which:

FIGS. 1a and 1b illustrate examples of a device according to one embodiment of the invention;

FIGS. 2a, 2b and 2c illustrate examples of position-marking areas according to a first embodiment of the invention;

FIGS. 3a and 3b illustrate an example of position-marking areas according to a second embodiment of the invention;

FIGS. 3c and 3d illustrate an example of position-marking areas according to an embodiment of the invention;

FIGS. 4a and 4b illustrate an example of position-marking areas according to a third embodiment of the invention;

FIGS. 5a and 5b illustrate an example of position-marking areas according to a fourth embodiment of the invention;

FIG. 6 presents the main steps of the method of use of a device according to an embodiment of the invention.

### DETAILED DESCRIPTION OF ILLUSTRATIVE EMBODIMENTS

### 1. General Principle

The general principle of an embodiment of the invention relies on the marking in relief, on a portable device comprising a touch screen, of one or more areas carrying position-marking information, called position-marking areas, enabling especially a sightless user to locate one or more corresponding areas of the touch screen.

Thus, a sightless user who wishes to activate a particular area of the touch screen first slides his finger on the device to detect the pieces of position-marking information in relief until he reaches the pieces of information identifying the particular area in question. He then shifts his finger towards the touch screen according to predetermined criteria described in detail here below to activate the particular area chosen on the touch screen.

According to the general principle of an embodiment of the invention, the position-marking areas may be situated at any place whatsoever of the device.

Advantageously however, these position-marking areas are situated “outside” the touch screen so that there is no risk that the user will involuntarily activate an application or enter wrong information through the touch screen when he is trying to detect the position-marking information according to an embodiment of the invention.

For example, if the touch screen represents a virtual keyboard with keys, a piece of position-marking information can correspond to a marking in relief, situated so as to be facing a key of the touch screen, so as to enable this key on the screen to be located.

In this case, a user can detect the position-marking information by sliding his finger on the different position-marking areas and then activate the desired keys by shifting his finger towards to the touch screen facing the detected position-marking information.

However, according to one embodiment described here below (third variant of the first embodiment), it is also possible for the user to detect position-marking information situated on the border of the touch screen while at the same time deliberately passing his finger on the touch screen, pending an audio signal emitted by the device whenever he passes over a predefined region of the touch screen (for example an intermediate area between two keys). In this embodiment, the activation of a particular area of the touch screen is made subject to an additional action by the user (for example a double-click, or a pressure on a specific key) so that the passing of his finger on the screen is not interpreted as the deliberate activation of this particular area of the touch screen.

Several cases can be envisaged to define the use of such a device according to an embodiment of the invention and especially to specify the way in which a sightless user can deduce the correct location of an area of the touch screen from his detection of the position-marking information in relief.

In a first case, it is assumed that the user knows the exact configuration of the position-marking information on the device as well as the exact configuration shown on the touch screen or else he is guided by auditory assistance given by the device (for example an audio message informs him of the configuration of the keys or simply informs him that the configuration of the keys is a “classic” configuration, etc).

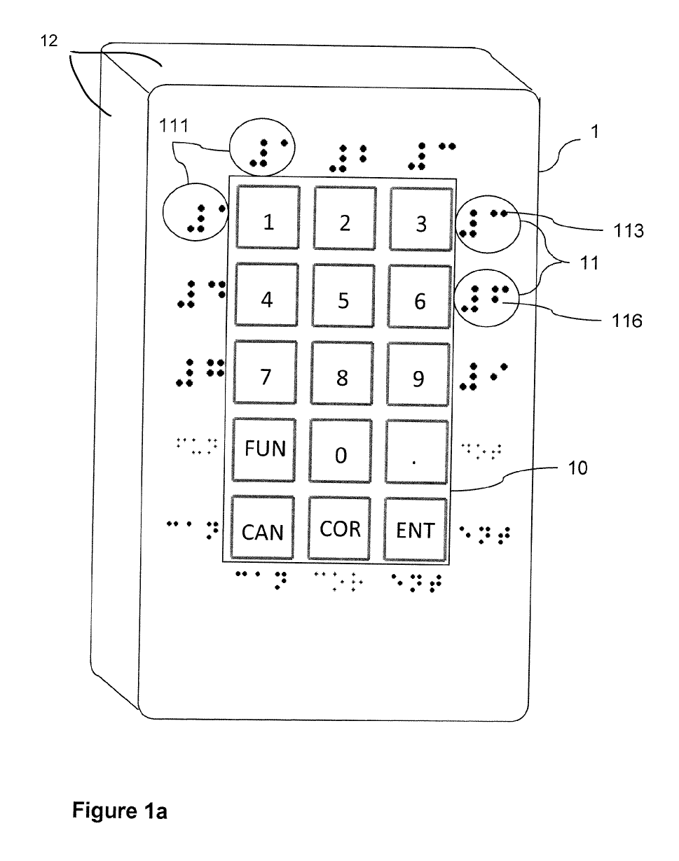

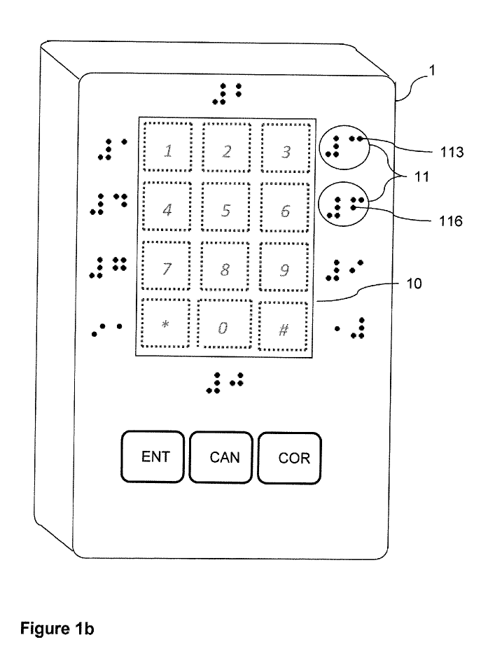

For example, he knows that the touch screen is subdivided into a certain number of distinct areas, the functions of which he knows. Furthermore, he knows that the position-marking information is around the touch screen, facing each of the distinct areas. In this case, the user can locate these areas of the touch screen without difficulty from his detection of the position-marking information. For example, if the touch screen represents a virtual keyboard configured as illustrated in FIGS. 1a and 1b, then the user knows that when he locates the number “1” for example, the corresponding key of the touch screen is to the right of the marking whereas, when he locates the number “2”, the corresponding key of the touch screen is below the marking or when he locates the number “6”, the corresponding key of the touch screen is to the left of the marking.

In another case, the user does not have prior knowledge of the exact configuration of the position-marking information on the device and the exact configuration represented on the touch screen. In this case, he must “test” the different areas around the position-marking information in order to deduce the direction towards which he must shift his finger, or his stylus, in order to activate the corresponding area of the touch screen. For example, the “test” on the different areas consists in shifting his finger by a few millimeters to the right, to the top, to the left and to the bottom of the position-marking information in relief so as to deduce the place where the touch screen is situated in relation to the position-marking information. For example, in the case of a device as illustrated in FIG. 1a, when the user has located the number “1”, he detects the edge of the terminal by shifting his finger above and to the left of the piece of position-marking information, and then detects another piece of position-marking information (in this case “4”) by shifting his finger to the bottom of the piece of position-marking information locating the number “1” and, from this, can deduce the fact that the tactile area of the screen is located to the right of the position marking for the “1” and so on and so forth.

According to one variant, a same piece of position-marking information can be repeated in two distinct position-marking areas in order to guide the user more efficiently. Thus, in FIG. 1a, the position-marking information 111 of the number “1” is presented to the left and to the top of the virtual key “1”. The position-marking information of the number “3” is also present twice, at the top and to the right of the virtual key “3”.

According to another variant, the markings 111 in relief are for example situated on one of the sides/edges 12 of the device or on a surface not parallel to the surface of the touch screen 10.

Here below we consider an example of a device according to an embodiment of the invention corresponding to an electronic payment terminal 1 as illustrated in FIGS. 1a and 1b comprising a touch screen 10 and, according to different embodiments, position-marking areas 11 that can carry different pieces of position-marking information 113, 116.

The general principle of an embodiment of the invention also relies on the fact that, for reasons of security, the display of the touch screen is deactivated when the device is used by a sightless user. This deactivation is illustrated in FIG. 1b by the virtual keys of the touch screen shown in grey and their outlines shown in dotted lines.

Thus, since the sightless user does not need the touch screen display since he benefits from the position-marking areas according to an embodiment of the invention, the use of the device has reinforced security by disturbing any observation on the part of a malicious individual who could deduce the PIN code, for example, of a sightless person by watching him as he keys it in. Indeed, if the virtual keys are not displayed, it would be difficult for an observer to identify the keys that have been activated.

Finally, the ergonomy of a device according to an embodiment of the invention is boosted by the presence, outside the touch screen, of certain keys of a keyboard in a standard form, i.e. in a non-tactile form. This configuration makes it possible to reduce the number of virtual keys on the touch screen and therefore also the number of position-marking areas needed, while at the same time enabling a sightless user to find a more classic configuration with standard keys.

For example, and as illustrated in FIG. 1b, the keys outside the touch screen are the “enter”, “cancel” and “correct” function keys.

### 2. Description of a First Embodiment

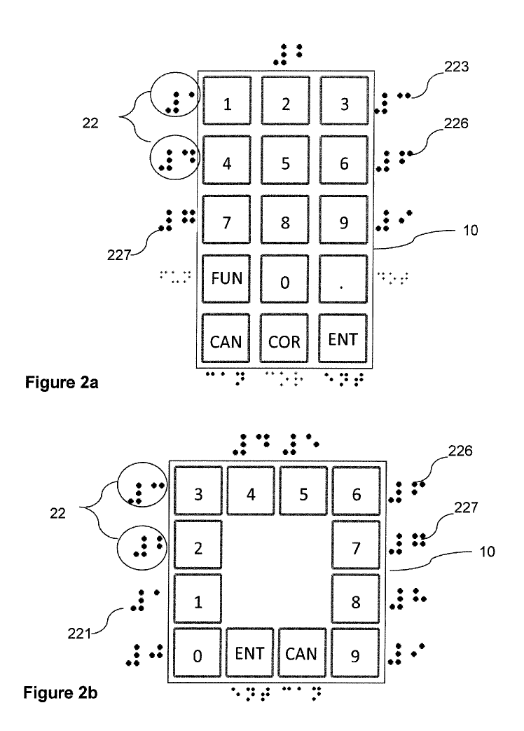

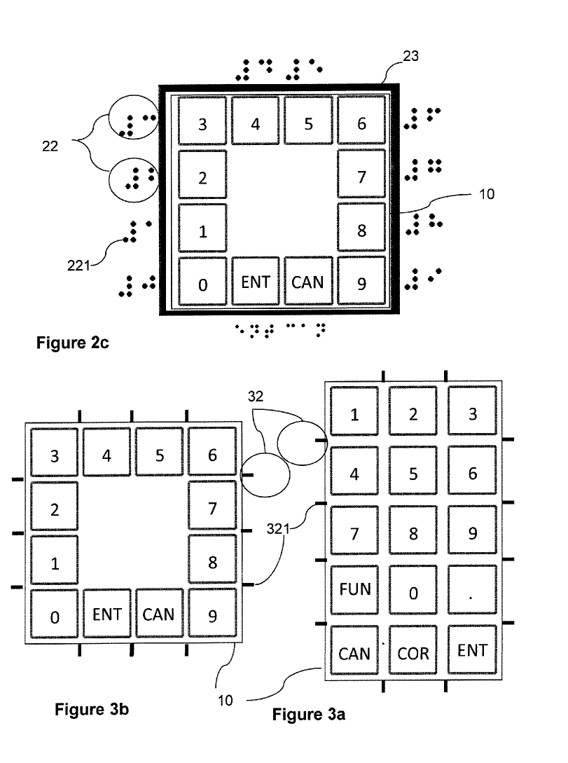

Referring now to FIGS. 2a to 2c, three variants of a first embodiment of the invention are presented.

Here, we consider only one part of the electronic payment terminal 1 of FIG. 1, namely the touch screen 10 representing a virtual keyboard as well as position-marking areas 22 carrying position-marking information (221, 223, 226, 227).

According to this first embodiment, these pieces of position-marking information correspond to representations in braille of the keys of the virtual keyboard shown on the touch screen.

FIG. 2a illustrates a first variant in which the touch screen represents a virtual keyboard according to a configuration known as a “classic” configuration. This variant especially enables the user to refer to a more familiar layout of the keys. Furthermore, this variant also provides for total compatibility between the use of an embodiment of the invention by a sightless user and the use of an embodiment of the invention by a user having no visual impairment.

FIGS. 2b and 2c for their part respectively illustrate a second and third variant in which the touch screen represents a keyboard “adapted” to use for sightless users. These two keyboard configurations vary by the position of the keys and also the number of keys represented.

Thus, the general principle of an embodiment of the invention enables the implementing of an embodiment of the invention for any type of representation of a virtual keyboard on the touch screen.

It is possible for example to envisage a case where the choice of the configuration of the virtual keyboard is proposed to the user, or to a person in charge of making the electronic payment terminal available (a tradesman for example), by an audio message. The configuration of the virtual keyboard can then for example be activated by an oral response requiring voice recognition or by the activation of a key (requiring the presence of a person other than the user when this user is sightless).

According to the first variant of this first embodiment (in which the keys of the virtual keyboard are organized “classically” as indicated here above) illustrated in FIG. 2a, the electronic payment terminal has a position-marking area facing certain keys of the virtual keyboard, in this case all the keys except the central keys.

Thus, twelve position-marking areas 22 carrying 12 distinct pieces of position-marking information (227, 223, 226, . . . ) enable a sightless user to locate all the keys of the virtual keyboard. Indeed, the keys at the periphery of the touch screen can be located “directly” through facing position-marking information and the central keys can be located by “deduction” and/or by means of a tactile marking directly present on certain areas of the screen, for example the presence of a dot in relief to locate and identify the key “5” (see the description of the fifth embodiment).

In particular, the keys corresponding to the numbers 1, 2, 3, 4, 6, 7 and 9 are located through distinct pieces of position-marking information, each corresponding to the respective representation in Braille of said numbers. The “correct”, “cancel” and “enter” keys are located through distinct pieces of position-marking information corresponding to the representation in braille of their respective English abbreviations, namely “COR”, “CAN” and “ENT”. Finally, the key “.” is located through a piece of position-marking information corresponding to the representation in braille of “DOT” and the “function” key is located through a piece of position-marking information corresponding to the representation in Braille of its abbreviation “FUN”.

In this variant, it is preferable for the sightless user to know the configuration of the keys of the virtual keyboard, especially so that he can deduce the central keys 5, 8 and 0 from the other keys marked according to this variant of the invention.

According to the second variant of this first embodiment, illustrated in FIG. 2b, the electronic payment terminal has a position-marking area facing each of the keys of the virtual keyboard, these keys being organized at the periphery of the touch screen (i.e. in a configuration adapted to sightless persons).

Here again, twelve position-marking areas 22 carrying 12 distinct pieces of position-marking information (221, 226, 227, . . . ) enable a sightless user to locate all the keys of the virtual keyboard. Indeed, certain keys of the “classic” virtual keyboard are not shown, such as “function”, “.” and “correct” in this case.

The braille representations described here above with reference to the first variant are used for this second variant and are not described again.

The third variant of this embodiment illustrated in FIG. 2c is identical to the second variant described here above and provides additionally for a region 23 enabling a different use of the position-marking areas of the virtual keyboard.

Thus, in this third variant, it is planned that the electronic payment terminal will have an intermediate area between two keys of the virtual keyboard, for example the region 23 illustrated in FIG. 2c (in bold). Thus, by sliding his finger on the region 23, i.e. “astride” the position-marking information and the touch screen, a sightless user detects the position-marking information according to an embodiment of the invention while at the same time having his finger on the touch screen.

However, as already indicated here above, this third variant calls for a different technique for activating the keys by additional action on the part of the user, in addition to pressure on the key considered. Indeed, the user necessarily puts pressure on the touch screen to navigate on the screen. The user must therefore carry out an additional action when he wishes to validate the activation of a key that he has pressed. For example, this additional action on the part of the user may be a “double pressure” on the key considered or a pressure on a specific key (not shown) which could be situated for example at the centre of the virtual keyboard.

### 3. Description of a Second Embodiment

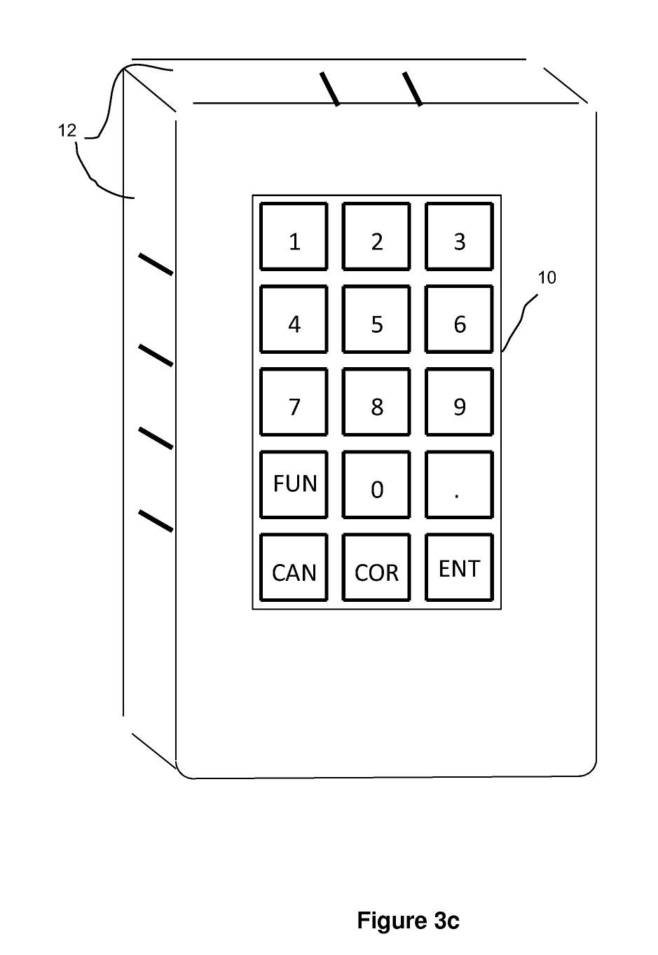

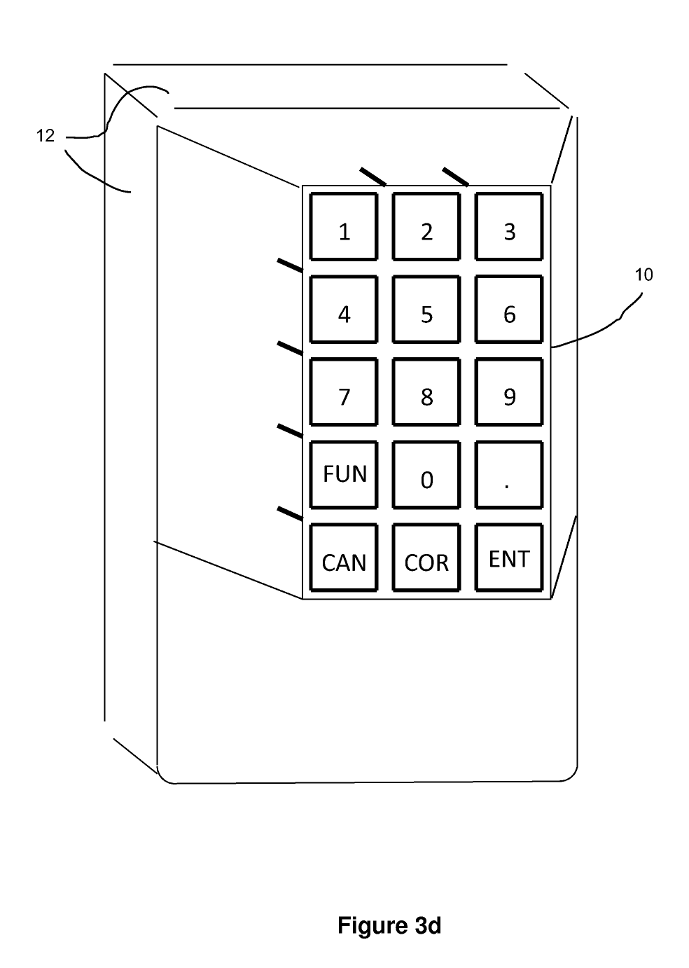

Referring now to FIGS. 3a and 3b, we present two variants of a second embodiment of the invention.

Here, we again consider only one part of the electronic payment terminal 1 of FIG. 1, namely the touch screen 10 representing a virtual keyboard as well as the position-marking areas 32 carrying position-marking information 321.

According to this second embodiment, these pieces of position-marking information correspond to markings, for example short lines situated around the touch screen perpendicularly to its edges, between each of the keys of the virtual keyboard. Thus, the position-marking information demarcates the boundaries between the keys of the virtual keyboard. This embodiment has the advantage of necessitating a position-marking system that is less important than in the previous embodiment, the markings used herein being all identical and simpler to make than representations in braille.

As in the first embodiment, FIG. 3a illustrates a first variant in which the touch screen represents a virtual keyboard according to a configuration called a “classic” configuration and FIG. 3b illustrates a second variant in which the touch screen represents a keyboard adapted to use by sightless users.

According to both variants, twelve markings are used to demarcate the boundaries between the keys at the periphery of the virtual keyboard for the first variant illustrated in FIG. 3a and all the keys of the virtual keyboard for the second variant illustrated in FIG. 3b.

Thus, a user knowing the configuration of the virtual keyboard can locate each of the keys by detecting, via the locating information, the boundaries between each of them.

FIGS. 3c and 3d illustrate an example of position-marking areas according to a variant in which the markings in relief are for example situated on one of the sides/edges 12 of the device (FIG. 3c) or on a surface not parallel to the surface of the touch screen 10 (FIG. 3d).

### 4. Description of a Third Embodiment

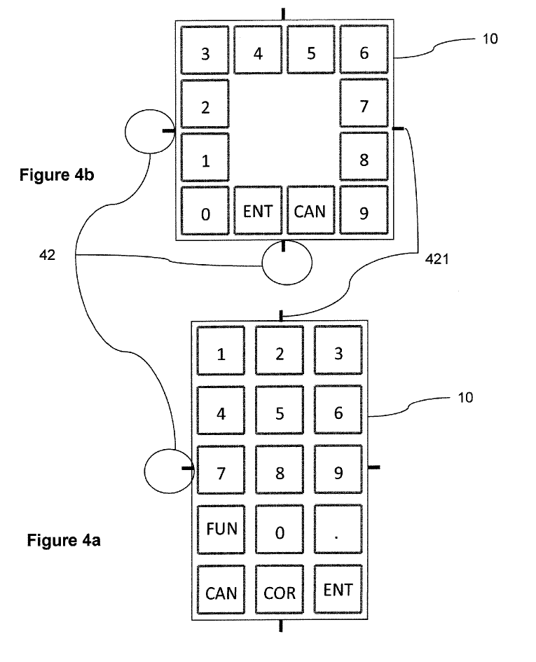

Referring now to FIGS. 4a and 4b, we describe two variants of a third embodiment of the invention.

Here again we consider only one part of the electronic payment terminal 1 of FIG. 1, namely the touch screen 10 representing a virtual keyboard as well as the position-marking areas 42 carrying position-marking information 421.

According to this third embodiment, these pieces of position-marking information correspond to markings, for example short lines, situated around the touch screen perpendicularly to the middle of each side of the touch screen. Thus, the pieces of position-marking information demarcate the middles of the sides of the virtual keyboard.

This embodiment, like the previous one, has the advantage necessitating a position-marking system that is less important than in the first embodiment, the markings used herein being all identical and simpler to make than in the representations in braille.

Furthermore, and as illustrated in FIGS. 4a and 4b, the number of markings needed is smaller than that of the previous embodiment.

Thus, both for the first variant in which the touch screen represents a virtual keyboard of a “classic” configuration and for the second variant in which the touch screen represents a keyboard adapted to sightless users, a user knowing the configuration of the virtual keyboard can locate each of its keys by detecting the middles of each of the four sides through the position-marking information.

### 5. Description of a Fourth Embodiment

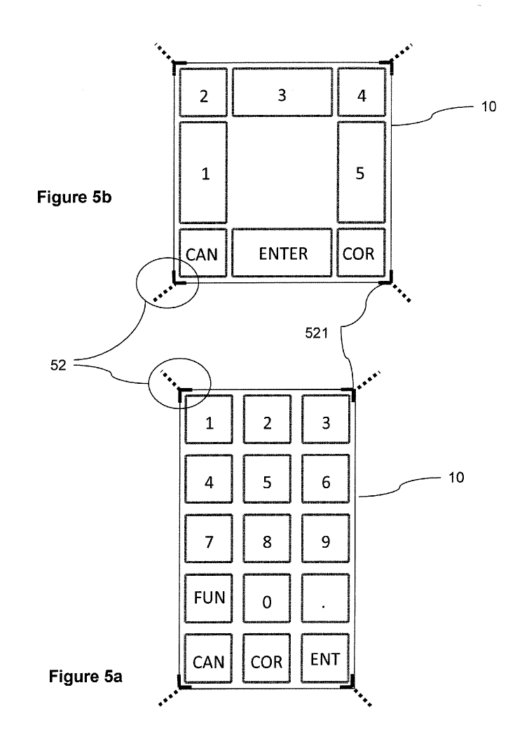

This fourth embodiment is close to the previous one except that the pieces of position-marking information correspond to markings demarcating the corners of the virtual keyboard. For example, the markings form angles situated outside the corners of the touch screen as illustrated in bold lines in FIGS. 5a and 5b, or again short lines positioned diagonally outside the corners of the touch screen as illustrated in dots in FIGS. 5a and 5b.

In this embodiment, the number of markings needed is again smaller than in the case of the other embodiments, but nevertheless requires good knowledge of the configuration of the keyboard by the user, especially for the first variant. Indeed, according to this variant illustrated in FIG. 5a wherein the touch screen represents a virtual keyboard with a “classic” configuration, five keys separate two markings along the sense of the height of the keyboard and three keys separate two markings along the sense of the width, making the locating of each of the keys between each marking slightly more complex. Furthermore, the central keys are also harder to locate by deduction.

According to the second variant illustrated in FIG. 5b, in which said touch screen represents a “special” keyboard, three keys separate two markings, thus facilitating use while at the same time limiting the number of markings. However, in this case, it is noted that not all the keys are represented on this “special” keyboard (in particular, the “0” and the numbers “6” to “9” are missing). This variant therefore necessitates for example, for the keying in of a base-10 classic four-digit confidential code, an encoding of this code in such a way as that it can be keyed in using only the keys available on the “special” virtual keyboard. It is possible for example to encode any classic confidential code to obtain a modified six-digit code using a base-5 system (i.e. in using only the numbers available on the “special” keyboard).

### 6. Description of a Fifth Embodiment

In this embodiment, the position-marking area or areas are situated on the surface of the touch screen, for example by application of an optical varnish, which makes it possible not to disturb the tactile operation of the screen while at the same time making it possible for example to demarcate one or more keys on the touch screen directly.

An embodiment of the invention in this embodiment makes it possible for example to demarcate the key “5” as on a standard keyboard.

Any other type of position-marking information can be envisaged.

Furthermore, this embodiment like the previous one requires a different technique for activating keys by an additional action of the user in addition to pressure on the key considered. Indeed, the user necessarily applies pressure on the touch screen to detect the marking or markings situated on the surface of the touch screen. As indicated here above, the user must therefore take additional action when he wishes to validate the activation of the key that he has pressed.

### 7. Description of a Sixth Embodiment

In this embodiment, we consider a method for using a device as described here above, more particularly in the embodiment where an intermediate area is provided between two keys, thus enabling the user to know when he passes from one key to another while at the same time having his finger on the keys on the touch screen (third variant of the first embodiment described here above).

As indicated here above, this embodiment of the device necessitates a different technique to activate the keys by additional action on the part of the user in addition to pressure on the key considered. Indeed, the user necessarily applies pressure to a touch screen to detect the fact that he has passed into an area between two keys, and this should not be interpreted as the activation of each of the keys pressed successively. The user must therefore carry out additional action when he wishes to validate the activation of a key that he has pressed.

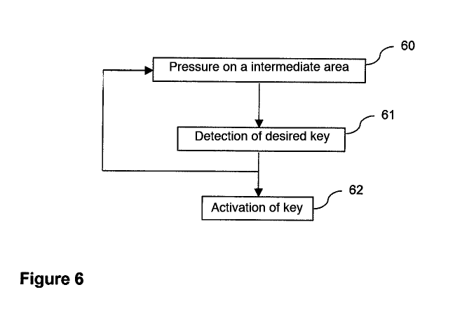

Thus, according to this embodiment, and as illustrated in FIG. 6, the sightless user slides his finger on a particular region (denoted as 23 and illustrated in bold lines around the touch screen in FIG. 2c) “astride” the position-marking information and the touch screen to detect the position-marking information according to an embodiment of the invention and on an intermediate area situated between two keys of the virtual keyboard. This pressure 60 by his finger on the intermediate area also gives rise to successive pressure on two successive keys of the touch screen. The user thus slides his finger on this particular region until, during a step 61 for detecting the desired key, he has detected the position-marking information corresponding to a key of the touch screen which he wishes to activate. When he has detected this position-marking information, he therefore applies pressure to the key that he wishes to activate and must implement additional action 62 to validate the activation of the key pressed.

For example, this additional action can be a “double pressure” on the key considered or pressure on a distinct specific key, for example situated at the center of the virtual keyboard.

At least one embodiment of the disclosure provides a portable device comprising a touch screen which can be used by any user, including a sightless user.

An embodiment provides a device of this kind that is also ergonomic for the user, whether or not he is sightless.

An embodiment provides a device of this kind that is a low-cost device and easy to manufacture.

An embodiment provides a device of this kind that complies with safety standards prevailing in the field of application of the device.

Although the present disclosure has been described with reference to one or more examples, workers skilled in the art will recognize that changes may be made in form and detail without departing from the scope of the disclosure and/or the appended claims.

1. A portable device comprising:
a touch screen; and
at least one area carrying a piece of position-marking information, called a position-marking area, identifiable by detection of a variation of a surface state on said device, wherein at least one position-marking area is situated on at least one side of said device or on a surface not parallel to the surface of said touch screen.

2. The device according to claim 1, wherein said position-marking information appears in relief relatively to at least one surface of said device.

3. The device according to claim 1, wherein the device comprises means for deactivating the display of said touch screen.

4. The device according to claim 1, wherein the device comprises at least one key outside said touch screen.

5. The device according to claim 1, wherein said piece of position-marking information corresponds to a marking demarcating a boundary between two distinct virtual regions of the touch screen.

6. The device according to claim 5, wherein said marking demarcates the middle of one side of said touch screen.

7. The device according to claim 1, wherein said piece of position-marking information corresponds to a marking that demarcates the width of a virtual key of the touch screen.

8. The device according to claim 1, wherein position-marking area is situated outside the touch screen and the variation of the surface state is selected from a group comprising:
a variation of the surface state embossed on a surface of the device;
a variation of the surface state etched on the surface of the device;
a combination of a variation of the surface state embossed on the surface of the device and a variation of the surface state etched on the surface of the device.

9. The device according to claim 1, wherein said position-marking area is defined by a coating on the surface of the touch screen of said device comprising an optical varnish.

10. The device according to claim 9, wherein said position-marking information corresponds to a marking that demarcates a predetermined key of said touch screen.

11. The device according to claim 1, wherein position-marking information corresponds to a representation in Braille of at least one key of said touch screen.

12. The device according to claim 1, wherein the device comprises audio means for guiding a user in browsing through an application rendered on the touch screen.

13. The device according to claim 1 wherein the device comprises disabling means for making activation of a virtual key of said touch screen by pressure applied by a user subject to the execution of an additional action by said user.

14. The device according to claim 1, wherein the device comprises means for signaling activation of a virtual key on said touch screen.
